(19) United States
(12) Patent Application Publication
(10) Pub. No.: US 2005/0047353 A1
(43) Pub. Date: Mar. 3, 2005

(54) Systems and methods for routing employing link state and path vector techniques

(76) Inventor: Susan Hares, Saline, MI (US)

Correspondence Address: PERKINS COIE LLP, P.O. BOX 2168, MENLO PARK, CA, 94026, US

(21) Appl. No.: 10/648,758

(22) Filed: Aug. 25, 2003

(51) Int. Cl. H04L 12/28

(52) U.S. Cl. 370/255; 370/466

(57) ABSTRACT

Routing protocols and algorithms, referred to collectively as “Link State Path Vector” (LSPV) techniques, are described. The LSPV allows the application of link-state techniques, such as flooding, to path vector protocols. Routing peers may be organized to form multiple levels of hierarchy. The LSPV mechanisms enable these peers to (1) exchange routing information via virtual links and (2) calculate the best network routes in light of the routing information. Routes may be selected on the basis of both topological distance and network policy. Such metrics may be determined by combining otherwise orthogonal metrics for IGPs and EGPs.

### CROSS-REFERENCE TO RELATED APPLICATION(S)

This application is related to U.S. Provisional Application No. 60/390,576, entitled “Fibonacci Heap for Use with Internet Routing Protocols,” U.S. Ulility Application ______ entitled “Fibonacci Heap for Use with Internet Routing Protocols,” U.S. Utility Application entitled “Systems and Methods for Routing Employing Link State and Path Vector Techniques,” filed on the same day herewith, and U.S. Utility Application entitled “Nested Components for Network Protocols,” also filed on the same day herewith, each of which is hereby incorporated by reference in its entirety.

### APPENDICES

Appendix A: Example of Shortest Path First Algorithm

### TECHNICAL FIELD

This invention is related to the field of networking, and more particularly, to protocols and algorithms for routing in networks.

### BACKGROUND

In communications networks such as the Internet, information is transmitted in the form of packets. A packet comprises a unit of digital information that is individually routed hop-by-hop on from a source to a destination. The routing of a packet entails that each node, or router, along a path traversed by the packet examines header information in the packet to compare this header against a local database; upon consulting the local database, the router forwards the packet to an appropriate next hop. This local database is typically called the Forwarding Information Base or FIB. The FIB is typically structured as a table, but may be instantiated in alternative formats. Entries in the FIB determine the next hop for the packet, i.e., the next router, or node, to which the respective packets are forwarded in order to reach the appropriate destination. The Forwarding information Bases are usually derived from global or network-wide information from a collective database. Each protocol names the collective databases to denote the type of information. Such databases are referred to generically herein as Network Information Bases (NIBs).

In implementations of the Internet Protocol (IP), the FIB is typically derived from a collective database, i.e., a NIB, referred to as a Routing Information Database or RIB. A RIB resident on a router amalgamates the routing information available to that router; one or more algorithms are typically used to map the entries, e.g., routes, in the RIB to those in the FIB, which, in turn, is used for forwarding packets to their next hop. The IP RIB may be constructed by use of two techniques, which may be used in conjunction: (a) static configuration and (b) dynamic routing protocols. Dynamic IP routing protocols may be further subdivided into two groups based on the part of the Internet in which they operate: exterior gateway protocols, or EGPs, are responsible for the dissemination of routing data between autonomous administrative domains, and interior gateway protocols, or IGPs, are responsible for dissemination of routing data within a single autonomous domain. Furthermore, two types of IGPs are in widespread use today: those that use a distance-vector type of algorithm and those that use the link-state method.

Route Selection Policies and EGPs

Routers typically support route selection policies which enable the identification of a best route amongst alternative paths to a destination. Routing selection policies may be pre-defined by a protocol, or may be otherwise distributed through a network, either statically or dynamically. An example of an EGP protocol which pre-defines route selection policies is exemplified by the Border Gateway Protocol version 4 (BGP-4), which allows route selection policy based on destination address and the BGP Path information. Routers also typically support route distribution policies, which govern the determination of which routes are sent to particular peers. Route distribution policies may be pre-defined by a protocol, statically configured, or dynamically learned. Dynamically learned policies can, in turn, be forwarded to a router within the same routing protocol, or, alternatively, forwarded via a separate protocol. As illustrative examples, BGP-4 allows for the inclusion of outbound route filter policies within BGP packets; the Rout Policy Server Language sends route distribution policy in a separate protocol. Some BGP-4 peers add or subtract BGP communities from e-BGP-4 path attributes, to mitigate policy processing on recipient peers. The addition of the BGP-4 Communities is sometimes called coloring of “dyeing” BGP-4 routes.

Link State Protocols

Link state routing protocols are typically based on a set of features uniquely tuned for each protocol. These features include:
The flooding link-state information.
Structure of link state information
Algorithms for computing a shortest path tree
Packets for communication.
Sub-protocols for neighbor acquisition and database synchronization, and

The sub-protocols for neighbor acquisition typically include indications for whether a link is up or down, and the creation of peer adjacencies. Extensions to the link state protocols are also available which allow for improved scaling. These extensions include:
Summarization of information within one level and area of the network for distribution into a higher level of routing process,
Expansion of information at higher level toward a lower level.

Examples of common link state protocols include OSPF and IS-IS. OSPF and IS-IS support two levels of hierarchy within the area of the network. Extensions to IS-IS in M-ISIS allow multiple Routing Information Bases (RIBs) with multiple level topologies be passed in the IS-IS protocol. Both the OSPF and ISIS protocols use a “hello” packet to signal that a peer is up on a link. A 2-way hello sequence between two peers involves the 1st peer sending a hello and the 2nd peer responding to the hello. A 3-way hello sequence between two peers involves the 1st peer sending a hello, the 2nd peer responding with a hello, and the 3rd peer responding with a third hello. Some hello sequences in other protocols (e.g., PLP) utilize a “heard-you” flag to indicate that the 2nd hello is in response to the first. Peer adjacency databases are generated per level per RIB, as are Shortest Path First (SPF) calculations; OSPF and ISIS utilize modified Dijkstra algorithms to compute shortest paths.

Path Vector Protocols

A prominent example of a path vector protocol is the Border Gateway Protocol, BGP v4. In this protocol, reachability information is passed from BGP-specific routers. Such reachability information may be inserted from Internal Gateway Protocols (IGPs), examples of which include OSPF, ISIS, RIP, IGRP or E-IGRP, an Exterior Gateway Protocol (EGP), which, in this case, is BGP, or static routes. BGP policy operates on the information contained in the route (for e.g., reachable prefix, AS Path, Path Attributes, NextHop router), the peer the route was received from, and the interface with which the route was associated. The Policy processing returns a metric that is associated with the route. Two routes first compare the two policy values to select the best route to be used. If the policy values are the same, the BGP protocol breaks ties between the two routes by comparison of the following:
1. AS Path length
2. Lowest origin,
3. Least value for the MED (if the MED is comparable)
4. Origin of: EGP 1st priority, IGP 2nd priority,
5. The route sent by a router with the least interior cost in the IGP,
6. Lower router-id of the peer sending the route,
7. The lowest neighbor address of the route.

Additionally, some implementations extend the BGP-4 specification to include the use the “time” of route creation for tie-breaking.

Routing Protocol Security

Routing protocols frequently secure data by use of security information, which may be statically configured or dynamically distributed. In the latter case, security often flows down a hierarchy of trust. A common trusted source originates certificates, which are passed down to a set of trusted devices; these trusted devices in turn pass down this “trust” model to other devices. This model of trust flow is referred to as security delegation. Public Key Infrastructure includes certificates are passed down a security delegation chain to given nodes, in conformance with the security delegation model. Secure BGP (S-BGP) utilizes such certificates to attest that BGP route information has been certified as correct.

BGP Policy

Routing policy allows routers to choose which routes are sent to their peers. Policies that govern the choice of routes sent to peers are referred to as route distribution policies. Route distribution policy can be pre-defined by a protocol, statically configured or dynamically learned. Dynamically learned policy can be sent within the same routing protocol that sends routes or in a separate protocol. BGP-4 includes outbound route filter policy within BGP packets. A Route Policy Server Language (RPSL) sends route distribution policy in a separate protocol. Some BGP-4 peers add or subtract BGP communities from the BGP-4 path attributes in order to shortcut some of the policy processing on the recipient peers. The addition of the BGP-4 Communities is sometimes called coloring or “dyeing” BGP-4 routes.

Policies may be loaded on individual routers via local static configuration or over an attached network. Manual configuration of policies on routers increases the likelihood of erroneous entries. Additionally, given the considerable number of nodes in communication over inter-networks, manual configuration suffers from obvious problems of scale and consistency. Dynamic configuration takes considerable time and system resources in ensuring consistency preservation, thereby delaying network convergence.

### SUMMARY

The invention includes protocols and algorithms referred to collectively by the rubric “Link State Path Vector” (LSPV). The LSPV is designed to generate a virtual network topology by connecting nodes, or “peers” via virtual links. The routing peers may be organized to form multiple levels of hierarchy. The LSPV mechanisms enable these peers to (1) exchange routing information via the virtual links and (2) calculate the best network routes in light of the routing information. According to embodiments of the invention, the routing information exchanged may include any one or more of the following:
Identifiers for a Routing Information Base
Destination prefix or address
Path information
Associated labels
Security information
Network Policies
Virtual Private Network identifier(s) and
cache information

Each of these categories of routing information are described further herein.

In embodiments of the invention, nodes may support routes originated by a single peer or announced by multiple peers. Routes associated with a pathway may be chosen in light of network policies forwarded by virtue of the LSPV technologies. In some embodiments, multiple path vector routes are allowed to the same destination. In some embodiments, the LSPV supports the passing of Border Gateway Protocol (BGP) routes within a policy domain; policy domains are further described in the U.S. Patent Application entitled “Establishment and Enforcement of Policies in Packet-Switched Networks,” (hereinafter, the “Policy Domain Application”) inventor Susan Hares, filed on the same day herewith, which is hereby incorporated by reference in its entirety. The LSPV algorithms select the best route from all possible routes, based on a metric which may be represented by the following proposition:
Best route(s)=Peer topology shortest path AND Best Path Vector based on policy

To elaborate, in embodiments of the invention, the shortest path in the virtual peer topology is calculated based on a link-state algorithm between the two peers. In some such embodiments, the LSPV employs a Dijkstra SPF calculation to determine the shortest path. In some such embodiments, the best Path Vector is subsequently determined based on a policy evaluation of the routing information, as described further herein; in alternative embodiments, the best path vector may be determined initially, and the shortest path selected from the best path vectors thereafter. Other implementations shall be apparent to those skilled in the art.

Additional algorithms that may be supported by the LSPV protocol include any one or more of the following features:
Establish a Virtual Peer topology based on virtual links
Calculate shortest path to each Virtual Peer and store results in a Virtual Peer Forwarding Information Base (FIB)
Create a Policy Results vector for each route based on path vector information
Perform Route Selection per each route based on the policy vector and shortest path to each Virtual Peer FIB
Summarize routes received at lower level in the hierarchy (n) for redistribution into a higher level (n+1)
Expand routes received at a higher level (n+1) for redistribution into a lower level (level n)

These and other algorithms supporting the LSPV are further described herein.

In embodiments of the invention, the Link State Path Vector supports BGP-4 within the policy domain. In embodiments of the invention, Link State Path Vector algorithms may replace BGP-4's path vector protocol algorithms to pass traffic within policy domains. Link State Path vector algorithms may also be used in with different protocols, non-limiting examples of which include variants of BGP, ISIS, and OSPF.

Link State Path Vector protocols may utilize network components, as further described in the U.S. Patent application entitled “Nested Components for Network Protocols,” inventor Susan Hares, filed on the same day herewith, which is hereby incorporated by reference in its entirety (hereinafter, the “Network Components Application”). Use of the network components enables the minimization of data flooded in the network, as well as fine grain, component level security. These and other embodiments are further described herein.

### BRIEF DESCRIPTION OF FIGURES

FIG. 1 illustrates an example of a network topology.

FIG. 2 illustrates an example of hello signals sent in a multi-level network architecture according to embodiments of the invention.

FIG. 3 includes databases supported by the Link State Path Vector Protocol according to embodiments of the invention.

FIG. 4 illustrates a template for a “hello” PDU according to embodiments of the invention.

FIG. 5 illustrates an example of a populated hello PDU according to embodiments of the invention.

### DETAILED DESCRIPTION

A. Introduction

The invention includes protocols and algorithms referred to collectively by the moniker “Link State Path Vector.” Embodiments of the invention include algorithms to achieve one or more of the following functions:
Establish topologies, referred to herein as Virtual Peer Topologies, which are based on virtual links and virtual adjacencies.

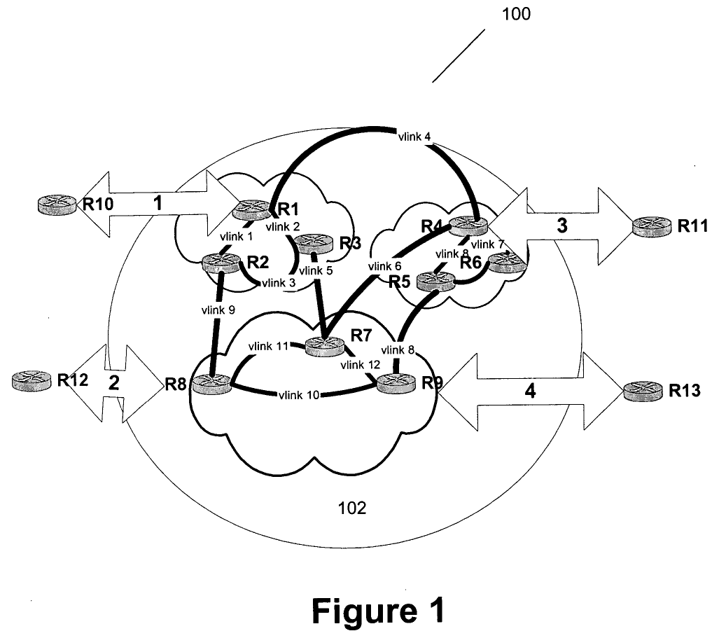

FIG. 1 illustrates a non-limiting example of a virtual peer topology 100. The virtual links vlink1-vlink10 and adjacencies are logical constructs denoting communication capabilities between nodes of a network. The virtual links and adjacencies may be instantiated by or more physical communication connections or channels, operating over any type of communication protocol. In embodiments of the invention, the virtual links can support point-to-point links or virtual multicast LANs with designated routers. The LSPV algorithms allow multiple level Hellos, 3-way/4-way negotiations sequences with quick drops, and heart beat hellos that may carry additional peer information updates. In embodiments of the invention, the LSPV adjacency processing may create one or more of the following: a local peer topology database, an LSPV adjacency database, a peer topology database, a Peer topology RIB, and a Peer topology FIB. These constructs are all further described herein.

Compute Shortest Path First (SPF) Calculations for the Virtual Peer Topologies.

In embodiments of the invention, these SPF calculations are modified Dijkstra algorithms; in some such embodiments, the modified Dijkstra algorithms are based on the routing algorithms utilized by IS-IS. These algorithms may be enhanced to perform any one or more of the following functions:
Support Peer-ID instances with ID tuples, which may have the form (Peer-id, Instance-id, and Peer-Address ID)
Support virtual multicast LANs with designated routers
Prioritize the retention of pathways that include policy domain edges, as further described in the Policy Domain Application.
Employ a Virtual Circuit metric in calculating the SPF and to calculate IGP metrics (normal and Traffic Engineering metrics) and EGP metrics for additional LSPV Traffic engineering calculations
Summarize routing information transferred between different hierarchy levels in a network, based only on LSPV summarization policy,
Expand routing information transferred between the different hierarchy levels based only on the LSPV expansion policy.

Create a Policy Results Vector for each route in a Policy Domain

As described in the Policy Domain Application, a set of policies may be run on the edge of a policy domain 102 in a particular order, whereby each such policy is run on a particular route in the given order. In embodiments of the invention, the results of each policy as applied to each route is saved and stored in a policy results vector, which is further described herein.

As an illustrative, non-limiting example, the results of a policy designated policy-1 run on a route designated route-1 will be stored in a policy vector denoted policy-result-vector-1, which is associated with route-1. Policy-2 run on route-1 will be stored in the policy-result-vector-2 associated with route-1. Thus, the policy results vector for a given route contains the results of number of policies run on that route. The results of the policies, e.g., the policy vectors, may in turn be processed to support additional network functions, non-limiting examples of which include route selection, route distribution, dynamic route distribution, policy distribution, and summarization or expansion of routing information in the middle of the policy domain.

Perform Route Selection Calculations in Link State Path Vector Algorithms to Support One or More Network Functions, Non-limiting Examples of which Include Fast Fail-Over, Multi-Path, Virtual Private Networks, and Multi-Protocol BGP

In embodiments of the invention, routes are selected based on Route Selection calculations, which select routes on the basis of (1) topological distance of the route, and (2) policy metrics. As a non-limiting example, a policy vector for a route may provide the results of various policy calculations, such as tie-breaking for BGP. In one such example, the BGP Forwarding Information Base (FIB) for the virtual topology provides the shortest path and metric between two peers for a Routing Information Base (RIB) (VPN or MPLS or MP-BGP). In case of a failure of an exit BGP router, a fail-over process may recalculate the BGP peer topology, without necessitating additional re-computation. This re-computation occurs at the speed of a small OSPF computation, rather than a lengthy Distance Vector comparison.

Algorithms to Summarize Routes Received at a Lower Level in a Network Hierarchy (n) for Redistribution into a Higher Level (n+1) of the Hierarchy

In embodiments of the invention, a group of routes may be summarized at a lower level for redistribution into a higher level; in some such embodiments, such summarization takes into account BGP-4 rules as well as Policy domain rules. In embodiments of the invention, this summarization may be passed as a network component. Network Components are further described in the Network Components Application. In embodiments of the invention, such summarization may be controlled by a summarization policy.

Algorithms to Expand Routes Received at a Higher Level (n+1) for Redistribution into a Lower Level (n)

Embodiments of the invention allow for the expansion of a route or a previous summarized route into groups of routes; such expansion may, in turn be controlled by an expansion policy, and in certain embodiments, this expansion policy may be combined with one or more of policy domain rules and BGP-4 rules. Precedence and interaction between these policies may be governed by the particular algorithms.

In non-limiting embodiments of an invention, inside a Policy domain, the Link State Path Vector supports BGP-4, or some variant thereof. Within such a policy domain, the routing policy is ensured to be consistent. BGP policy result vectors may be calculated at the edge of the policy domain and passed as part of the data—as discussed in the Policy Domain Application, policy domains allow consistent policy to be run on the edge of the domain, with the results of the policy calculation operated on in the “middle” of such a policy domain. In embodiments of the invention, Link State Path Vector algorithms can replace BGP-4's path vector protocol algorithms within a policy domain to pass traffic. Link State Path vector algorithms may comprise variants of common routing protocols, examples of which include BGP, ISIS, and OSPF. In embodiments of the invention, each such protocol may employ a customized flooding mechanism to pass information.

Embodiments of the invention also include data structures for the Link State Path Vector, which may include any one or more of the following:
a local LSPV Peer topology database [LocalPeer]
a local LSPV Peer adjacency database [PeerAdj]
a Peer topology database with paths to all peers [Peer RIB]
a Peer shortest path FIB [Peer FIB]
a Ignored pathways with Policy Domain Edge points [Ignored-paths]
a Link State database with information about the routes originated by each LSPV peer
a Policy information Base (which, in non-limiting embodiments, may include 9 types of policy, as discussed in the Policy Domain Application)
a Path Vector database per Routing Information Base with reachable routes and policy vectors per route, and
a FIB for the selected LSPV routes.

In embodiments of the invention, the Link State Path Vector can export any of these databases to the policy domain calculations.

In embodiments of the invention, the Link State Path Vector protocols use network components to minimize the data traffic when flooding information. In some such embodiments, the LSPV protocols use the network component mechanisms to secure each portion of the data flooded by the link-state path vector algorithms. In some such embodiments, the network components may re-secure information at intervals specific to the network components. If a security attack focuses on a network component, the re-securing interval can be reduced to provide additional computational barriers to cracking any securing code. These and other embodiments are described in further detail herein.

B. Algorithms for Generating Virtual Peer Topologies

In embodiments of the invention, the virtual peer topology may be generated by reference to a Routing Information Base (RIB). Algorithms for generating the virtual peer topology may support functions such as:
Use of virtual links to create Virtual Peer Adjacencies
Creation of local peer topology databases
Creation of Peer Adjacency Databases
Flooding of peer information amongst peers
Calculation of the virtual peer topology, and
Creation of a BGP Peer Forwarding Information Base (BGP Peer FIB)

Each of these functions and algorithms is described in further detail herein.

(1) Use of Virtual Links to Create Virtual Peer Adjacencies

The virtual links between peers may be created by any protocol or combination of protocols that allow communication between nodes. Non-limiting examples of communication channels which may constitute virtual links include point-to-point connections or multicast connections within a scoped area. Point-to-point links which may be supported by LSPV include, but are not limited to, TCP, TCP MD5, and IP in IP encapsulation based on the GRE protocol. The multicast links scoped within an area include, but are not limited to multicast groups on a physical LAN and/or reliable multicast transport within an area. In embodiments of the invention, the virtual links pass a link status (up or down) and a type of virtual link to code resident in the nodes which is responsible for supporting Virtual Adjacencies.

In embodiments of the invention, virtual adjacencies between peers may be established by use of “hello” packets. These hellos may be employed for multiple purposes, including establishment of the virtual adjacency and communication of additional peer information. A type of hello signal employed by the invention is referred to as a heart beat hello, comprising hello packets which are transmitted along virtual links on a periodic basis. In embodiments of the invention, 3-way handshakes may be employed to declare that a virtual adjacency is “up,” and 4-way handshakes may be used to establish lasting connections between the virtual peers, enabling the peers to exchange heart-beat hellos; upon completion of the 4-way handshake, the connection is said to be in “heart-beat” mode. In embodiments of the invention, the “heart-beat” mode allows additional information to be passed. In some embodiments, if the “heart-beat” is missed once, the connection drops backs into 3-way until it a hello is received in response from the remote site.

In 3-way mode, if the “hello” is missed for a peer adjacency dead interval, the connection is disconnected. If no messages are received in a hold time interval, the connection is disconnected. It is recommended that hellos are sent at a rate of ⅓ the hold-time interval.

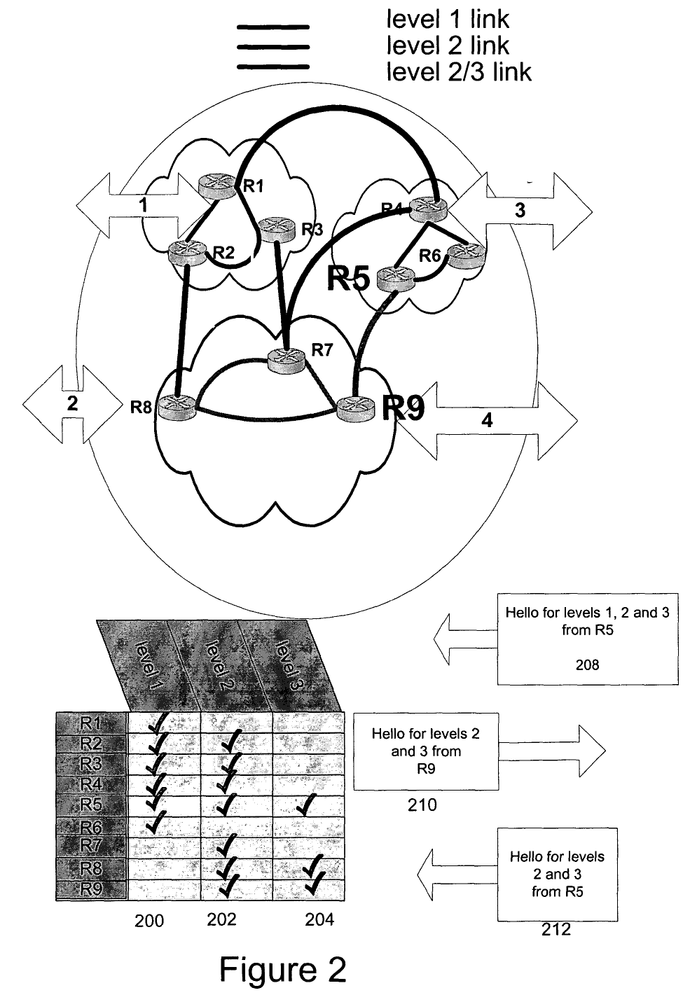

Embodiments of the invention allow a peer to support levels or hierarchy in the topology. In some such embodiments, individual hello signals may be apply to single or multiple levels of the topology. When the hello information is identical for multiple levels, the peer may either send a hello per level, or, alternatively, send a single hello with a level field, indicating a level mask. An example of multi-level hellos operative in a hierarchical topology is depicted in FIG. 2. The network topology of the policy domain 206 is organized into three levels 200 202 204, and the individual nodes/routers R1-R9 are each operative at one or more of the levels 200 202 204. For instance, node R5 is operative at all three levels, and accordingly, forwards hellos 208 operative at all three levels. Nodes R9 and R5 are operative at levels 2 and 3 202 204, and accordingly forward hello signals operative at these levels 210 212. In embodiments of the invention, a level field in a Packet Data Unit (PDU) for a hello may include two special values, a level-mask identifier and an extended-levels identifier.

(a) 3-way up/4-way Full Handshakes on Point-to-Point Links

In embodiments of the invention, upon detection that a virtual link is up, the virtual peer coupled to the virtual link sends a hello message, which may include one or more of the following items:
Levels supported by this peer
Peer address of the source of the Hello
Identifier for a Virtual Circuit, as described further herein
a hold time
Maximum routes supported per prefix
Autonomous System number
Policy domain identifier
Security information

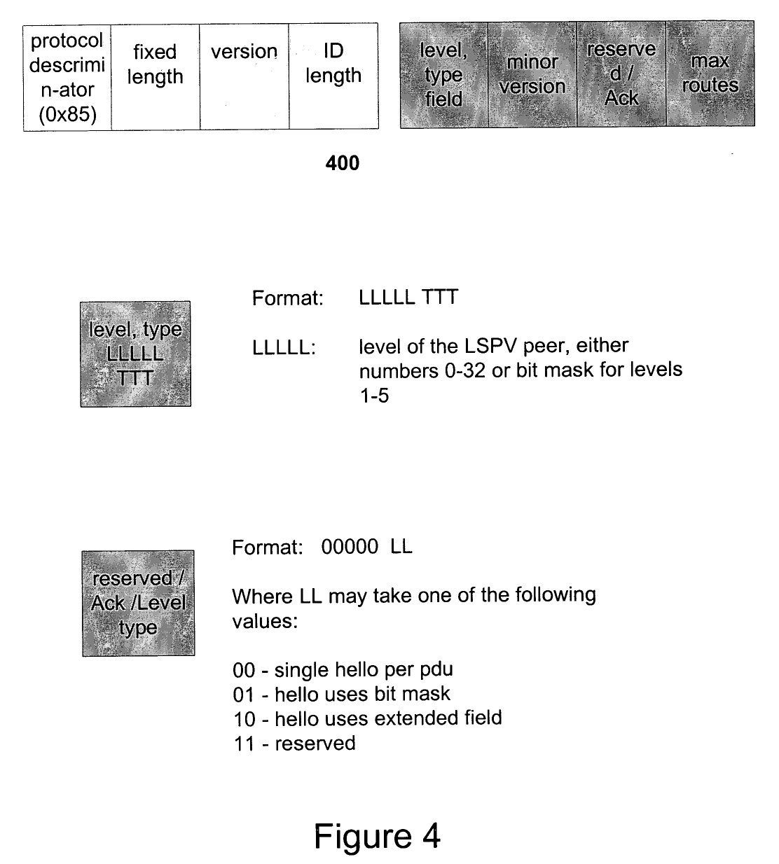

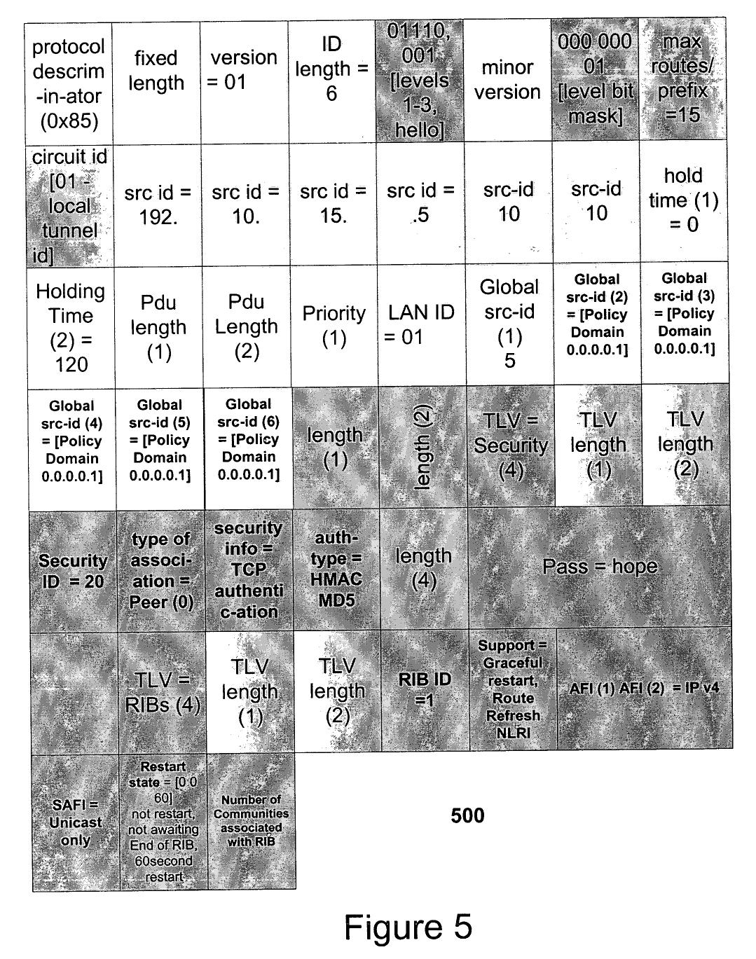

In some embodiments, the hello may contain additional fields, which may take the form of negotiated parameters or other peer information, as elaborated herein. An example of a hello PDU 500 forwarded in the virtual topology is illustrated in FIG. 5, and a template for certain fields in the Hello PDU 400 is presented in FIG. 4. The negotiated connection parameters are undertaken once the peer re-engages in the 3-way discussion, without dropping the current adjacency. The peer information may forwarded in 4-way handshake without re-negotiation. The negotiated parameters may include any one or more of the following:
BGP or LSPV capabilities this neighbor supports
RIBs that this neighbor supports
Information about format of packets using network components in a packet.

The peer information parameters may include any one or more of the following:
Links this neighbor has to other Peers
Alternate addresses supported by this neighbor
Local routes associated with a Peer, and
Peer policy

Upon receiving a hello PDU, a peer validates the packet format. In an illustrative, non-limiting example of the invention, If the optional fields are not present, the following is implied by default:
No additional links to neighbors are present,
No alternate addresses are supported by neighbors,
No additional BGP or LSPV capabilities are supported,
Only the default RIB is supported,
No additional peer policy is supported, and
Default packet formats are used.

These default implications are for example purposes only—other default states will be apparent to those skilled in the art.

During the negotiation phase of the 3-way handshake, the local peer determines if it can support the virtual adjacency at the LSPV Peer levels with the capabilities, RIB, Peer type (e.g., IBGP/EBGP), peer identity (e.g., AS, Address), Policy Domain ID, security and packet formats. A peer may subsequently send a packet with the peer information. The originating peer sends back a hello with the original information and this peer as virtual connection. The 3rd hello completes the 3-way handshake. After a 4th hello received from the remote peer, sets this connection in “heart-beat” mode. During heart beat mode, optional fields may be updated at any time.

If any of the negotiated fields change, the LSPV Peer sends a Hello message with the changed negotiated parameters, issues an “start of adjacency re-negotiation” message to the adjacency processing, initiates an adjacency re-negotiated processing, and enters a two way receive-send state (2-way-rs). Upon re-negotiation of parameters, the LSPV adjacency processing issues a “adjacency up” indication with the new set of parameters. The 4-way mode will again allow information fields to be updated at any time.

(b) Election of the Designated Router on Virtual Multicast LAN

In embodiments of the invention, a priority field in the LSPV PDU allows a designated router/peer to be elected for a virtual multicast group per level of the LSPV field. In embodiments of the invention, the priority field/flag of the HELLO includes two flags, designated ‘Designated Peer (DP) election’ and ‘packet priority’. If the DP election flag is set in the priority field, the LSPV peer elects a designated peer to represent the virtual multicast group. In embodiments of the invention, the designated peer with the highest value is elected as the peer.

If the local peer is configured to use DP election, the local peer sets the “DP election” flag and the priority value in the priority field. In embodiments of the invention, upon receiving the Hello from the remote peer that also sets the DP election flag, the election rules include one or more of the following:
Elect the LSPV node with the highest priority.
If both LSPV nodes have the same priority, the LSPV uses the LSPV node with the lowest numerical Peer-ID from the source-id field.
If priority and source field Peer ID are the same, compare the instance-ID field from the BGP neighbor field.

(c) Validation of the Peers

In embodiments of the invention, peers are validated as determined by local policy. Information validated by the peers may include any one or more of the following:
Peer address
Levels of Hellos requested,
VCID and priority (the VCID and local policy configuration will indicate whether the data sent to the remote neighbor via hop-by-hop routing or via a tunnel)
Hold time,
Maximum routes per prefix supported,
Autonomous System number,
Policy domain identifier, denoting the policy domain in which the peers are configured to reside, and
Security information passed in the hello.

The peers may validate additional information by mutual agreement.

(2) Creation of the Local Peer Topology Database

The Hello process adds information to the LSPV Peer topology database. In embodiments of the invention, when a virtual circuit comes up, a local peer sends a Hello to a corresponding remote peer. The peers may enter states denoted as: one way send (1-way-s), one way receive (1-way-r), two way send-receive (2-way-sr), two way receive-send (2-way-rs), three-way send-receive-send (3-way-srs), three way receive-send-receive (3-way-rsr), four-way handshake (4-way). An example algorithm for instantiating these states is presented as follows:
1. Clear a “hold down timer”
2. If the “hold time timer” is running, wait until the hold time timer expires.
3. Set the state to “init”
4. Store the information that will be sent in the first hello, the LSPV peer topology database,
5. Send a Hello with the information as indicated above and set the state to “1-way-s”
6. State: 1-way-s:
   a. Listen for a hello or Close for the “hello” interval time,
   b. If a hello is received, go to step 7
   c. If a hello is not received, increment the count of “hellos” sent
   d. If the count is less than “max-hellos”, go to step 5.
   e. If the count is greater than “max-hellos” or a Close is received, set the hold-down timer and go to step 2.
7. Set the state to ‘2-way-sr’:
   a. Process the hello to determine if this peer can accept the “hello” information and get back status. Status will be (Ok, negotiate, or drop)
   b. OK status:
      If the peer accepts the hello information, send a hello echoing the agreed upon hello parameters with the local peer information, process the local peer adjacency as up, and go to step 9.
   c. Negotiate status:
      If the local node wants to negotiate the hello information, send a “hello” with suggested alternatives to the “hello” parameters, and set the state to: ‘2-way-rs’, and go to step 8.
   d. Drop status:
      If the local node wants to drop the connection, it sends a Close (BGP-4 type, close), sets the state to “init”, sets the hold-down timer to the hold down interval, and goes to step 2.
8. State: ‘2-way-rs’:
   a. Listen for a hello for the “hello” interval time
   b. If a hello is received, go process the hello information and get back the status. The status will be (OK, negotiate, or drop).
   c. If a close is received, set the state to “init”, set the hold-down timer, and go to step 2.
   d. If hello or a close, not received in the hello interval, go to step 5.
   e. OK status: change the state to “3-way-rsr”, send a hello, process the local adjacency as up, go to step 10.
   f. Negotiate status: If the local node wants to negotiate the hello information, send a hello with the alternative ‘hello’ parameters and go to state 7.
   g. Drop status: Send Close, sets the state to “init”, sets the hold-down timer to hold interval and goes to step 2.
9. State: 3-way-srs
   a. Listen for a hello
   b. If receive a hello, process it. The Status will be (OK, Negotiated, or drop).
   c. If close received, set the state to “init”, set the hold-down timer, and go to step 2.
   d. If a hello or a close is not received in the hello interval, go to step 5.
   e. If OK: change status to full-heart-beat and go to step 11.
   f. If negotiate: send hello with negotiated parameters and return to the top of step 9.
   g. If Drop status: Send Close, set the state to init, set the hold-down timer to interval and go to step 2.
10. State: 3-way-rsr
   a. Listen for a hello
   b. If receive a hello, process it. The status will be: OK, Negotiate or drop.
      i. If OK, change status to “full-heart-beat” and go to step 11.
      ii. If negotiated parameters: Send hello with negotiated parameters and go to step 9.
      iii. If drop status: Send Close, set state to init, set the hold-down timer to the interval and go to step 2.
   c. If receive close, set the state to ‘init’, set the hold-down timer, and go to step.
   d. If hello timer expires, send hello.
   e. If dead interval timer expires, send “Close”, set state to init, set hold-down timer, and go to step 2.
   f. If Close is received, set state to init, set hold time timer, and go to step 2
11. Status: full-heart-beat
   a. Listen for hello
   b. If receive hello, process the hello in “heart-beat-mode” which allows variation on information parameters. Result of processing will be a status of Ok, Drop, or Informational parameter change, negotiated parameter change.
      i. If OK, go to the top of 11
      ii. If Drop, set state to init, drop the connection, set the hold-down timer to the interval and go to step 2.
      iii. If information parameter changes, update the parameter and go to step 11.
      iv. If negotiated parameter changes indicated, process negotiated parameters. The result will be either “new hello” or Close connection.
         1. If close connection, send “Close message”, set the state to init, drop the connection, and set the hold-down timer to the interval and go to step 2.
         2. If the “new hello” is the processing, send the new hello with approved negotiated parameters and go to state 12.
   c. If hello interval timer expires, send “hellO” with latest information.
   d. If router dead interval expires, send “close”, set the state to init, set the hold-down timer.
   e. If a Close is received, set the state to init, drop the connection, set the hold-down timer to the interval and go to step 2.
12. Status: 3-way-negotiate-rs
   a. Listen for hello
   b. If receive hello, process the hello in “renegotiate mode”. The status from the processing is: OK, Drop, Negotiate parameters.
      i. If OK, respond with a hello, issue “adjacency-renegotiated” to adjacency state machine.
      ii. If Drop, send a “close”, set the state to init, set the hold-down timer, and go to step 2.
      iii. If Negotiate, process the negotiated parameters. If negotiated parameter changes indicated, process negotiated parameters. The result will be either “new hello” or Close connection.
         1. If close connection, send “Close message”, set the state to init, drop the connection, and set the hold-down timer to the interval and go to step 2.
         2. If the “new hello” is the processing, send the new hello with approved negotiated parameters and go to state 12.
   c. If hello interval timer expires, resend the “hello” with the negotiated parameters, and go to the top of step 12.
   d. If the router dead interval expires, send the “close”, set the state to init, set the hold-down timer, and go to step 2.
   e. If a Close is received, set the state to init, set the hold-down timer, and go to step 2.

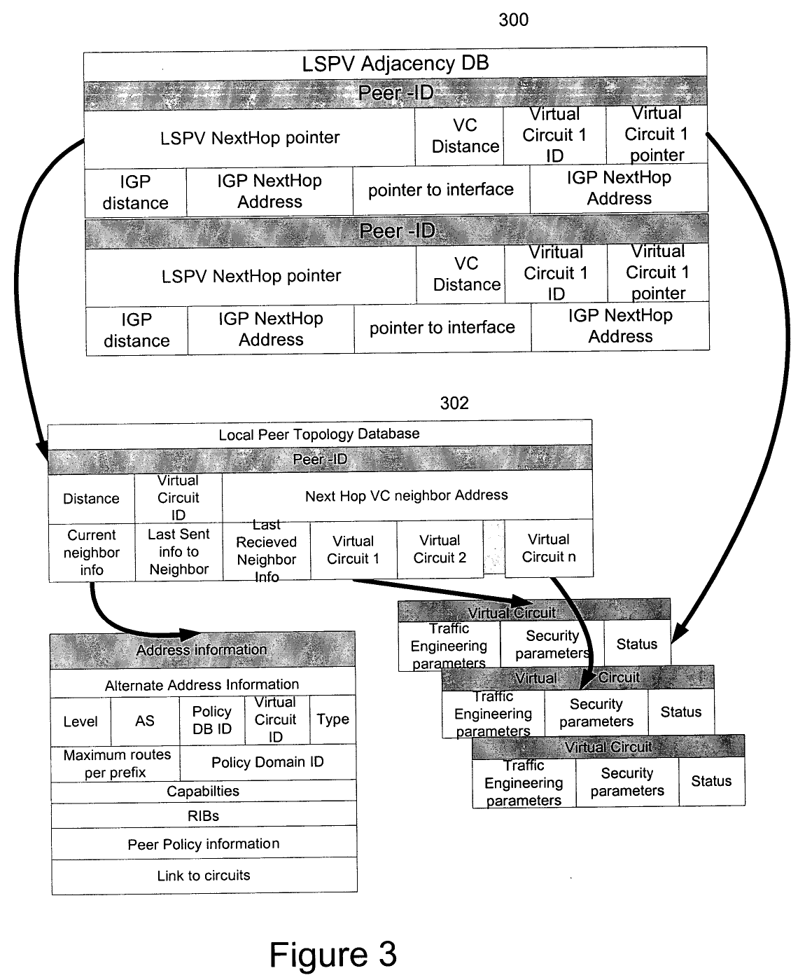

In embodiments of the invention, a database contains an entry for each remote peer configured for attachment to the local peer. Adjacency and peer topology databases 300 302 are used in embodiments as illustrated in FIG. 3. Database entries may include any one or more of the following:
LSPV Neighbor
   Virtual Circuit 1:
      Distance, Virtual Circuit-ID, NextHop VC neighbor address
      Neighbor information (1st filled at 3-way handshake)
         Address information
         Alternate Address information
         Level, AS, Policy-ID, Peer type
         Maximum routes per prefix, Policy Domain ID
         Capabilities, RIBs, Peer Policy info ID
         Links (with neighbor ptr)
   My last sent information: Address information
      Alternate Address information level, AS, Policy-ID, Peer type
         Maximum routes per prefix, Policy Domain ID
      Capabilities, RIBS, Peer Policy info-id
      Links (with neighbor ptrs), network component ptrs
   Neighbor last received info: Address information
      Alternate Address information level, AS, Policy-ID, Peer type
         Maximum routes per prefix, Policy Domain ID
      Capabilities, RIBS, Peer Policy info-id
      Links (with neighbor ptrs), network component ptrs
   Virtual Circuit-1 (Virtual Circuit-ID, NextHop VC Neighbor)
      Traffic engineering information on Virtual circuit-1
      Security information on Virtual Circuit1
      Status: off, 1-way-s, 1-way-r, 2-way(s-r/r-s), 3-way (s-r-s)/(r-s-r)
   Virtual Circuit-2 (Virtual Circuit-ID, NextHop VC Neighbor)
      Traffic engineering information on Virtual circuit-1
      Security information on Virtual Circuit1
      Status: off, 1-way-s, 1-way-r, 2-way(s-r/r-s), 3-way (s-r-s)/(r-s-r)

An example of a format for the database 300 is illustrated in FIG. 3.

(3) Creation of the LSPV Adjacency Database

Once an LSPV peer enters a 3-way state, an LSPV adjacency is created. In embodiments of the invention, for each RIB and adjacencies between peers, the following information is queried from the routing infrastructure.
LSPV VC Neighbor
IGP distance to NH VC neighbor
IGP next-hop on distance to neighbor,
Interface to send packets out to get to next neighbor,

A recursive lookup process provides a link between the Virtual Circuit-1 (ID and neighbor) and the interface and next hop neighbor to create the following adjacency information for each circuit.
LSPV neighbor, VC distance, IGP distance
   VC Circuit-1 (VC-id, next hop VC Neighbor),
      IGP distance to NH VC neighbor, next hop neighbor, interface
      Pointer to neighbor information in local database

If the parameters are “re-negotiated” on a circuit, the adjacency processing updates the information. If the underlying routing signals a change to the route over which this virtual circuit information runs, the IGP information is updated.

(4) Flooding of LSPV Peer Adjacency Information to Neighbors

Upon coming to full adjacency, the LSPV floods the LSPV Adjacency information to each of its peers, and schedules a calculation shortest path calculation for the peer topology. The LSPV also floods any peer policy, routing or policy information in link state adjacency packets. The LSPV contains the following types of information, grouped by global type.
Data format (TLV 0)
BGP neighbor addresses (TLV 1)
BGP neighbor addresses (TLV 2)
BGP capabilities (TLV 3)
BGP security (TLV 4)
BGP LSP (TLV 5)
BGP RIB IDs (TLV 6)
BGP peer Policy (TLV 7)
BGP Routes (TLV 8)
BGP Path (TLV 9)
BGP Labels (TLV 10)
BGP Route Policy Results (TLV 11)
BGP AS path (TLV 12),
BGP NextHop (TLV 13),
BGP Communities (TLV 14),
BGP Aggregator (TLV 15),
BGP MISC (TLV 16),
BGP Policy (TLV 17),
BGP Dynamic Policy (TLV 18).

(5) Creation of the LSPV Peer Topology FIB

The SPF operation on the LSPV results in Forwarding Information Base for shortest virtual path (based on virtual circuits) between the LSPV peers. In a non-limiting, illustrative embodiment, the SPF algorithm uses one or more of the following constants in its calculations:
Maximum number of BGP-5 peers at a level,
Maximum number of BGP-5 levels, and
Routing metrics for each circuit.

The forwarding database consists of a tuples for each LSPV peer LSPV Neighbor, VC Distance, Policy-Domain status (edge or center)
Virtual Circuit-1 (Virtual Circuit-ID, NextHop VC Neighbor)
Virtual Circuit-2 (Virtual Circuit-ID, NextHop VC Neighbor)

The recursive lookup process provides a link between the Virtual Circuit-1 (ID and neighbor) and the interface and next hop neighbor to create the final BGP Peer FIB:
LSPV neighbor, VC distance, IGP distance, Policy domain status (Edge or center)
   VC Circuit-1 (VC-id, next hop VC Neighbor),
      IGP distance to NH VC neighbor, next hop neighbor, interface
   VC Circuit-2 (VC-id, next hop VC Neighbor),
      IGP distance to NH VC neighbor, next hop neighbor, interface
   . . .
LSPV neighbor, VC distance, IGP distance
   VC Circuit-1 (VC-id, next hop VC Neighbor),
      IGP distance to NH VC neighbor, next hop neighbor, interface
   VC Circuit-2 (VC-id, next hop VC Neighbor),
      IGP distance to NH VC neighbor, next hop neighbor, interface
   . . .

This BGP Peer FIB is used in the calculation of the BGP Route Reachability.

(6) Policy Domain Edge Peers

An entrance peer is an LSPV peer that is on the edge of the Policy domain that receives either a LSPV route or a Path Vector route. The exit peer is the peer at the Edge of a policy domain that redistributes a route outside of a Peer domain. Both an entrance and an exit LSPV peer are Edge peers. In embodiments of the invention, to aid in determining consistent policy, the LSPV BGP Peer FIB and RIB can be searched for Edge Peers.

C. SPF Calculation for LSPV Virtual Peer Topology

In embodiments of the invention, a Shortest Path First (SPF) calculation is performed to provide the shortest path between LSPV peers, as indicated by the topology of the peers. This section presents an SPF calculation for the LSPV. The examples presented herein constitutes a modified Dijkstra calculation, tailored to the LSPV—other variants shall be apparent to those skilled in the art.

The SPF calculation employed herein may include one or more of the following features and parameters:
A Peer ID is may be a tuple, such as the following 3-tuple (Peer-id, instance-id, and Address ID)

(The instance ID allows for the same peer address to be used for multiple instances of the same code. The Address ID allows for different families on the same node to optionally operate as different nodes in the calculation)
Support for virtual multicast LANs with Designated Peers/Routers,
Support for storing information about Policy Domain edges with pathways cut from normal SPF calculation due to metric. This additional allows post processing of Policy domain pathways that did not get processed.
Per Virtual circuit storing of additional information to ease BGP-4 interaction, including:
   BGP-4 Status of link (I-BGP, E-BGP),
   Confederation status,
   Route Reflector status,
Per Virtual circuit storing of additional information to aid traffic engineering of LSPV
   BGP-4 path level:
   Traffic engineering metrics at BGP peer level,
   IGP metrics and IGP traffic engineering metrics.
Summarization of routes between levels based Summarization policy and retention of original routes,
Expansion policy between multiple levels based on the expansions policy and retention of original routes.

(1) Databases

In non-limiting embodiments of the invention, databases and algorithms employed by the SPF calculations may include modifications of standard databases and algorithms for the IS-IS protocol, which are described as follows:
PATHS

The PATHs database represents an acyclic directed graph of the shortest paths from BGP peer 1 to any other peer. The paths are stored as a set of triples in the form of
[N, d(N), Adj(N)]
N is the LSPV Identifier for the LSPV peer. It is a tuple with peer-id, instance-id, address-id. The tuple format allows the identification to terminate at Peer-id if the peer-id is unique.
d(n) is N's distance from S (total metric value) from N to S (i.e. the total metric value from N to S). Distance N is the virtual distance between the two LSPV peers.

Adj(n) is the set of adjacencies that S may use to forward to LSPV peer N.

When a node is placed on PATHs, the path designated by it position in the graph is guaranteed to be a shortest path.

Each [N, d(N), Adj(N)] node has associated information. This associated information can be route information [TLV 8-TLV16] or Route Policy information [TLV 17-TLV 18] or Peer information (peer addresses, local routes, IGP association, RIBs, capabilities, Security validation, security hierarchy, peer LSP flooding information) [TLV 1-7], or network component formats [TLV 0].
TENT

This is a list of triples of the form (N, d(N), adj(N)) are defined above for PATHs. TENT can intuitively be thought of as a tentative placement of a system in PATHS.

For example, for the Triple (N, 10, (A)), is in TENT means that N is placed in the PATHS, d(N) would 10 via adjacent router A. LSPV Peer N cannot be placed in PATHs until it is guaranteed that no path short than distance 10 exists.

A tuple, of (N, 10, (A,B)) in Tent means that if N were placed in the PATHS, 10 distance away would be via either adjacency A or B.
Ignored Pathways Vectors

This is a list of ignored LSPs, with distance (P,N) that exceeds the pathway length where Peer P and Peer N are both edge Policy domain peers. IgnoredPathWays have the format: (P,N,LSP-array) Where LSP array is list ordered of ignored sequence numbers ordered by the tuple of originating peer and LSP sequence number.

(2) Overview of the SPF Algorithm

The basic algorithm, which builds paths from scratch, starts out by putting the LSPV Peer doing the computation on PATHs. Tent is then pre-loaded from the local adjacency database.

Note that a LSPV peer is not placed in PATHs unless no shorter path to that system exists. When a LSPV Peer N is placed in PATHs, the path to each neighbor M of LSPV Peer N through N, is examined, as the path to N plus the link form N to M. If (M,*,*) is in PATHs, this new path will be longer, and thus ignored. If either the neighbor M or the Peer N are on the edge of the Policy Domain, the ignored pathway is stored in the Ignored Pathway database.

If (M,*,*) is in TENT, and the new path is shorter, the old entry is removed from TENT and the new path is placed in TENT. If the new path is the same length as the one in TENT, then the set of potential adjacencies {adj(M))} is set to the union of the old set (in TENT) and the new set {adj(N)}. If M is not in TENT, then the path is added to TENT.

Next the algorithm finds triple {N,x,Adj(N))} in TENT, with minimal distance x. N is placed in PATHs. We know that no path to N can be shorter to x at this point because all paths through systems already in PATHs have already been considered, and paths through systems in TENT will have to be greater than x because x is minimal in TENT.

When TENT is empty, PATHS is complete.

The full algorithm for the SPF algorithm is in Appendix A.

(3) Algorithms to Create Policy Vector

The metric for calculating the LSPV Peer to each prefix via each route may be described by the following equation:
Metric=policy-metric (policy-results)+Peer Topology distance

The policy metric is an algorithmic function of the policy-results vector. This section describes algorithms to:
Creation the policy results vector,
Calculation of the policy-metric based on the policy-results vector.

The policy results vector is calculated from the network information base used by the link state. The examples are taken from the IP network information bases for VPNs as supported by BGP-4.

(a) Source of Information

The LSPV routes and network information is either
Generated locally to a LSPV peer from route redistributed from another peer, or
Flooded from a LSPV peer.

In embodiments of the invention, a Path Vector reachability process calculates processes routes to each based on a network prefix. A fully qualified route may contain the following items: RIB, prefix, Path-info, Label-info, Policy-results-vector, Peer-path-info A network route prefix may be originated by different LSPV peers. The network prefix may be associated with the same Path-info or different path-info.

(b) Calculation of Policy Vector

Upon receiving the route information at the edge of a policy domain, the LSPV peer runs a route policy on the generating a “policy results” per policy per route. An equation for the policy of a peer is as follows:
Policy-vector-result(1)=policy-1 (route, peer-pathways)

By way of illustrative example, assume a topology of 4 LSPV peers given as follows. LSPV Peer 1, Peer 4, and Peer 5 are on the edge of the Policy Domain; Peer 2 and LSPV Peer-3 are not on the edge of the policy domain. When a piece of routing information is exchanged with LSPV Peer 1, Peer 1 runs the policies associated with two LSPV pathways:
Pathway 1: Peer 1 to Peer 4 via Peer 2
Pathway 2: Peer 1 to Peer 5 via Peer 3.

There are two policies for route selection and route distribution inside the Policy Domain denoted as “policy-1” and “policy-2”. Peer 1 calculates the policies at the edge of the Policy domain as follows:
Policy-vector-results(1)=policy-1(route,peer-pathway-1,peer1),
Policy-vector-results(2)=policy-1(route,peer-pathway-1,peer2),
Policy-vector-results(3)=policy-1(route,peer-pathway-1,peer4),
Policy-vector-results(4)=policy-2(route,peer-pathway-2,peer1),
Policy-vector-results(5)=policy-2(route,peer-pathway-2,peer3),
Policy-vector-results(6)=policy-2(route,peer-pathway-2,peer5),

The policy-vector results are per peer and per policy. The results are based on a particular instance of Policy denoted by a “policy-id” in the results vector. The results also save the peer-pathway and the peer associated with each results. The peer-pathway can be a specific pathway or all pathways. The peer can be a single peer or a group of peers or all peers. The policy vector stores the following information:
1) LSPV Policy major value (preference1)
2) LSPV Policy metrics for tie breaking (preference2, metrics1-metric4)
2) AS Path length tie break value
3) Lowest Origin tie break value
4) Least MED election tie break value
5) EGP 1st, IGP 2nd tie break value
6) IGP distance tie break value
7) Router-id tie break value
8) Peer address tie-break value.
9) Path Attribute modification values.

Path Attribute modification policies are determined by policy. Examples of Path Modification are additions of BGP communities to the BGP Community attribute or Label attribute changes.

(c) Calculation of Policy Metric from Policy Vectors

The Policy metric is an encoding of the policy results for a route at a particular peer in the network. Following the example above, peer 3 would access an ordered n-tuple with the following information pieces:
1) LSPV Policy preference tuple
   a) preference 1
   b) preference 2
   c) preference 3
   d) preference 4
2) LSPV Tie breaking tuple
   a) AS Path length tie breaking value
   b) Lowest Origin tie breaking value
   c) Least MED election tie break value
   d) EGP/IGP value tie break values
   e) IGP distance tuple
      (metric1, metric2, metric3, metric 4)
   f) Router-id tie break value
   g) peer address tie break value
   h) age of route tie-break value

The concatenation of the tuples constitutes the policy metric. In embodiments of the invention, the policy metric may be stored in the following order:
[policy-major-value] [policy-tie-breakers] [tie-break values]

For each prefix:
1. Truncate tie-breaker values at the tie-breaker level supported by node LSPV peer policy specifies which of 7 additional tie breakers may be used to select the route. Within a LSPV vector domain, the route selection criteria uses the same method of calculating the policy metric. This stage truncates the policy metric at that value: an LSPV_tie_truncate value indicates the tuple at which the policy is truncated. In embodiments of the invention, the Peer policy validation ensures that the peers all share the same LSPV_tie_truncate value.
2. Zero fill any policy-metric not used.
3. Fill any used tie-breaker with appropriate default
   (4) Route Selection Calculations

In embodiments of the invention, the LSPV Peer calculates the metric to each prefix in a RIB/NIB via each route via a metric presented as follows:
Metric=policy-metric(policy-results)+Peer Topology distance

This section describes the Route selection calculations based on the above metric. If multiple BGP Peer topologies have the same policy metric, the BGP Peer topologies provides equal Cost multi-path the BGP Peers at the same distance.

(a) Path Vector Route Selection

The first comparison within a Path Vector Route selection is performed by reference to the major policy metric. If two routes exist with the same major policy metric, a 2nd level of tie breaking occurs with the BGP Policy tie breakers (preference 2, preference3, and preference4) in order. If multiple routes still exist, with the same tie-breakers, the “path-MED” set of tie-breakers are used to select from the candidate routes. In embodiments of the invention, the tie-breakers include one or more of the following:
BGP Policy tie-breaking values.
AS Path length (tie break 1)
Lowest Origin (tie break 2)
Least MED election (tie break 3)
EGP 1st, IGP 2nd (tie break 4)

Within a mixed BGP-4/LSPV Policy domain, the policy metrics may contain two parameters (IGP distance and Router-id), and optionally a 3rd (time-of-route-creation). The full group of tie breakers are referred to as the “bgp-4 tie-breakers. The 8 tie-breakers in the metric are referred to as time-based-bgp-4 tie-breakers.

Within a BGP-5 only domain, the BGP Peer Policy may either select to augment the base BGP Policy value with:
Path-MED tie-breakers (1-5)
BGP-4 tie-breakers (1-5, and 6-7 tie-breakers)
Time based Tie-breakers

Once routes for a particular prefix have been sorted by the best Policy value+tie breakers, if multiple routes are allowed, the BGP-5 peer topology allows equal cost multi-path routes to exist.

D. Summarization

(1) Restrictions on Summarizing from Level n and Redistributing at Level n+1

In a multi-level environment, if the LSPV peers restrict the amount of information sent to the next level up the LSPV peer information keeps all routes that:
Have the same preference based on policy,
Utilize the MED field to tie break, and
Stay within the same IBGP mesh for an AS or AS confederation.

The LSPV peers exchange the IBGP mesh information and AS confederation are configured into the LSPV peer, and exchanged in the HELLO packets that pass LSPV Peer information. A Policy RIB ID identifies the combination of the Route policy (normal and dynamic) and the Peer policy.

In embodiments of the invention, summarization policies that restrict the flow of the more specific route(s) within a policy domain may have one or more of the following features:
Consistency (as defined in the Policy Domain Application), and
Matched with a corresponding expansion policy.

To aid in detection of consistent policy, in embodiments of the invention, summarization and expansion policies operate only on routes within the same Policy Domain. In some such embodiments, summarization policy is only engaged when the current policy instance matches the policy instance of those policy domain edge routers generating the Policy results. A Policy RIB identifier identifies a Policy instance. This Policy RIB ID is passed along with the Policy results.

(2) Summarization Mechanisms for Link State Path Vector within a Policy Domain

Summarization occurs within a Policy domain based on the policy results run at the entrance to a Policy Domain. Policy domains run policy at the entrance to a Policy domain. Summarization policy may include the following components:
Summarized route,
“Matches” on routes that cause summarized route to occur, and
Specified routers and levels in the LSPV virtual topology at which the summarization occurs

An algorithm for summarizing the route is presented as follows:
1) Match the route based on summarization match policy,
2) Exclude routes from the match that:
   Do not have the same Policy Domain ID,
   Do not have the same Policy RIB ID
   Do not match the same level of BGP summarization restrictions
3) If the match still contains routes, generate the summarization.
4) Flood the summarization route with the following additional information based on the LSPV redistribution policy and the following summarization specific information:
   LSPV peer that created the summarization,
   Level at which the summarization occurred,
   Policy Domain ID,
   Policy RIB ID,
   Level of BGP summarization restrictions

By default, the summarization policy floods all summaries and all routes to all levels. Additional restrictions of information flow are possible, and allow for consistent policy in a policy domain, as will be apparent to those skilled in the art.

E. Expansions of Routes

(1) Restrictions on Expansions from Level n+1 to Level n

In a multi-level environment, if the LSPV peers restrict the amount of information sent to the next level up the LSPV peer and supports BGP-4 interaction, the LSPV Peer keeps all routes that:
Have the same preference based on policy,
Utilize the MED field to tie break, and
Stay within the same IBGP mesh for an AS or AS confederation.

The LSPV peers exchange the IBGP mesh information, and AS confederations are configured into the LSPV peer and exchanged in those HELLO packets which pass LSPV Peer information. A Policy RIB ID identifies the combination of the route policy (normal and dynamic) and the peer policy.

Expansion policy that increases the flow of the more specific route(s) within a policy domain ensures the following qualities:
Consistency (as defined in the Policy Domain Application)
Matched with a summarization policy or be a de-aggregation policy that is consistent with BGP expansion policy

(2) Algorithms for Expansions Between Levels

Expansion occurs within a Policy domain based on the policy results run at the entrance to a Policy Domain. In embodiments of the invention, expansion policies may have the following components:
Matches for “expanded” route,
Policy on how to expand routes including the processing of summarization restrictions,
BGP Expansion level, and
Policy on redistribution of expanded route.

An algorithm for expanding the route is presented as follows:
1) Match the route based on expansion match policy,
2) Exclude routes from the match that:
   Do not have the same Policy Domain ID,
   Do not have the same Policy RIB ID,
   Do not match the BGP expansion level, or
   Are restricted by the processing restrictions of the expansion.
3) If the match still contains routes, generate the expansion
4) Flood the expansion route with the following additional information based on the LSPV redistribution policy and the following expansion specific information:
   LSPV peer that created the expansion
   Level at which the expansion occurred,
   Policy Domain ID
   Policy RIB ID
   Level of BGP expansion restrictions

### F. CONCLUSION

From the foregoing, it will be appreciated that specific embodiments of the invention have been described herein for purposes of illustration, but that various modifications may be made without deviating from the spirit and scope of the invention. Accordingly, the invention is not limited except as by the appended claims.

Appendix A

Example of Shortest Path First Algorithm

A non-limiting example of an SPF algorithm that may be used by embodiments of the invention is presented as follows. Many modifications, variants, and alternatives shall be apparent to those skilled in the art. The decision process algorithm described herein may be run once for each supported level of the BGP peers. For example, at Level 1 the BGP Peer runs the algorithm using the Level 1 Link state database to compute Level 1 paths. At Level 2, the BGP Peer runs the LSP to compute Level 2 paths.
Step 0 Initialize TENT and PATHs to empty, Initialize tentlength to (0,0).

Tentlength is the path length of elements in TENT under examination.

a) Add (SELF,0,W) to PATHS, where W is a special value indicating traffic to SELF is destined for TCP layer on this box, rather than forwarded

b) Now pre-load TENT with the local adjacency database.

Each entry made to TENT is marked as being an I-LSPV peer or an E-LSPV peer. If the adjacency is marked as an LSPV peer, the remote AS is encoded.

For each adjacency Adj(N), on established LSPV links to the LSPV Peer N of SELF in state “Up”, compute
d(n)=cost of the parent circuit of the adjacency (LSPV Peer N) obtained from the metric
Adj(N)=the adjacency number of the adjacency to LSPV Peer N

c) if a triple <N, x, {Adj(m)}> is in TENT, then:
if x=d(N), then Adj(M)←{adj(M)}U Adj (N)

d) if there are now more adjacencies in {Adj(M)} than maximumPathSplits, then remove excess adjacencies. If any of the removed adjacencies are on the edge of a policy domain, store the removed adjacencies in the “Ignored Pathways” database.

e) if x<d(N), do nothing

f) if x>d(N), remove <N, x, {adj(M)}> from TENT and add the triple<N,d(N),Adj(N)>

g) if no triple <N, x{Adj(M))} is in TENT, then add <N, d(N), Adj(N)> to TENT

h) Now add any LSPV Peers to which the local LSPV Peer does not have any adjacencies, but which are mentioned in neighboring pseudo-node LSPs. The adjacency for such systems is set to the Designated LSPV Peer.

i) go to Step 2
Step 1: Examine the zeroth Link State PDU of P, the LSPV Peer just placed on PATHs

The zeroth Link State PDU, is the Link State PDU with the same LSPV Peer ID as P, and LSP number zero.

a) if this LSP is present, and the LSP Database Overload bit is clear, then for each LSP of P, compute
dist(P,N)=d (P)+metricₖ(P,N)
   for each BGP Neighbor N of the BGP Peer P. d(P) is the second element of the triple
<P,d(P),{Adj(P)}>
   and metricₖ (P,N) is the cost of the link from P to N as reported in P's Link State PDU.

If the LSP database overload bit is set, ignore the LS packet.

b) if dist(P,N)>MaxPathMetric, check to see if both (P and N) are in the policy domain edge. If so, add this pathway to the array of ignored pathways.

c) if [N,d(N),{Adj(N)}] is in PATHs, then do nothing

[Note: d(N) is less than dist(P,N), or else N would not have been put in PATHs. An additional sanity check may be done here to ensure d(N) is in fact less than dist(P,N)]

d) if a triple, <N,x,{Adj(N)}> is in TENT, then:
1) if x=dist(Pn), then Adj(N)←{Adj(N)}U Adj(P)
2) if there are now more adjacencies in {Adj(N)} then maximumPathSplits, then
   remove excess adjacencies. Store any excess adjacency with a Peer at the edge of the Policy Domain in the Ignored Pathways Database.
3) If x<dist(P,N), do nothing.
4) If x>dist(P,N), remove <N,x{adj(N)}> from TENT and add <N,dist(P,N),Adj(P)}>

e) if no triple <N,x,{adj(N)}> is in TENT, then add (N,dist(p,N),{P}> to TENT
Step 2: If TENT is empty, stop, else

a) Find the element <P,x{Adj(P)}>, with minimal x as follows
1) if an element (*,tentlength,*> remains in TENT in the list for tengtlength, choose that element. If there is more than in the list for tenglength, choose one of the elements (if any) for a system which is a pseudonode in preference to one for a non-pseudonode. If there are no more elements in the list for tentlenght, increment tenghtlength and repeat step 2.
2) Remove <P,tentlength,{Adj(P)}> from TENT
3) Add (P,d(p),Adj(p)}, to PATHs
4) if the system just added to PATHs was an End system, go to step 2, Else go to
   Step 1.
   Step 3: Evaluate the Connectivity between Policy Domain edges

If the Policy domain edges are not connected via a single level or by summarization, warn that the Policy domain is broken.

1. A system for exchanging routing information in one or more networks, the one or more networks including a plurality of at least partially interconnected nodes, the protocol comprising:
a plurality of path vectors for routes in the one or more networks, the plurality of path vectors included in the routing information;
a multi-tier hierarchy amongst the plurality of nodes in the one or more networks, such that the one or more networks are operative to expand or summarize the routing information to select nodes in the plurality of nodes based on a rank of the select nodes in the multi-tier hierarchy;
a flooding mechanism for exchanging the routing information amongst the plurality of nodes;
a link-state database in each of the plurality of nodes, the link state database including a virtual topology of the one or more networks, such that each of the plurality of nodes is operative to generate the link state database from the routing information, the link-state database further including the plurality of path vectors for routes in the one or more networks.

2. The system of claim 1, wherein a convergence time of the one or more networks exchanging the routing information via the protocol is less than an average convergence time for a topologically equivalent network connected via OSPF.

3. The system of claim 1, wherein a convergence time of the one or more networks exchanging the routing information via the protocol is less than an average convergence time for a topologically equivalent network connected via BGP.

4. The system of claim 1, wherein the one or more networks includes one or more autonomous systems.

5. The system of claim 4, wherein the one or more networks includes two or more autonomous systems.

6. The system of claim 5, wherein each of the plurality of nodes maintains a list of logically adjacent nodes from the plurality of nodes.

7. The system of claim 6, wherein the list of logically adjacent nodes are non-equivalent to physically adjacent nodes.

8. The system of claim 7, wherein two or more logically adjacent nodes from the plurality of nodes reside on two or more distinct autonomous systems from the one or more networks.

9. The system of claim 1, wherein each of the plurality of nodes is operative to populate the link-state database from a shortest path first algorithm.

10. The system of claim 9, wherein the shortest path first algorithm is a modified Dijkstra algorithm.

11. The system of claim 1, wherein each of the plurality of nodes is operative to create adjacencies other nodes in the one or more networks via a four-way handshake.

12. The system of claim 11, wherein the protocol includes a hello message, such that the hello message is exchanged periodically between adjacent nodes after the four-way handshake.

13. The system of claim 12, wherein the hello message includes a modified hello PDU with one or more additional parameters.

14. The system of claim 1, wherein the multi-tier hierarchy includes one or more higher level tiers, such that nodes in the one or more higher level tiers are in communication via an Exterior Gateway Protocol (EGP).

15. The protocol of claim 14, wherein the EGP is a version of Border Gateway Protocol.

16. The protocol of claim 1, wherein the multi-tier hierarchy includes one or more lower level tiers, such that nodes in the one or more lower level tiers are in communication via an Interior Gateway Protocol (IGP).

17. The protocol of claim 16, wherein the IGP is a link state protocol.

18. The protocol of claim 17, wherein the IGP is one of OSPF and IS-IS.

19. A method of selecting routes at a first node in a communications network, the method comprising:
establishing a plurality of nodes logically adjacent to the first node, establishing the plurality of nodes further including completing a four way handshake with each of the plurality of logically adjacent nodes;
receiving a plurality of routing tables at periodic intervals from the plurality of adjacent nodes;
populating a routing table local to the first node, populating the local routing table further including selecting a plurality of routes to the plurality of nodes from the routing tables, selecting the plurality of routes further including determining a path length for each of the plurality of routes and applying a policy vector to each of the plurality of routes, applying the policy vector including generating one or more metrics for discriminating between the plurality of routes.

20. The method of claim 19, wherein the one or more metrics are in a prioritized order.

21. The method of claim 19, wherein the selecting the plurality of routes further includes resolving ties between two or more routes in the plurality of routes.

22. The method of claim 21, wherein the path length for the two or more routes are identical.

23. The method of claim 22, wherein resolving ties between the two or more routes further includes selecting a route from the two or more routes based on the one or more metrics.

24. The method of claim 23, wherein the one or more metrics includes BGP path attributes.

25. The method of claim 23, wherein the one or more metrics includes BGP Multi Exit Discriminator attributes.

26. The method of claim 23, wherein the one or more metrics includes autonomous system path lengths from the two or more routes.

27. The method of claim 19, further comprising:
selecting one or more optimal routes from the plurality of routes based on the one or more metrics.

28. The method of claim 27, wherein the one or more optimal routes have minimal values for the one or more metrics.

29. The method of claim 27, wherein the one or more optimal routes ensure that the communications network is load balanced.

30. The method of claim 27, wherein the one or more optimal routes have a minimal length.

31. The method of claim 27, wherein the one or more metrics includes a distance metric indicating, for each of the two or more routes, a length of an internal gateway path traversed by the two or more routes.
